(19) United States
(12) Patent Application Publication
(10) Pub. No.: US 2004/0036596 A1
(43) Pub. Date: Feb. 26, 2004

(54) Security system and methods

(76) Inventors: Steven Heffner, Mesa, AZ (US); Seth Klondar, Ellicot City, MO (US)

Correspondence Address: Michael W. Goltry, PARSONS & GOLTRY, Suite 260, 340 East Palm Lane, Phoenix, AZ, 85004, US

(21) Appl. No.: 10/630,987

(22) Filed: Jul. 30, 2003

Related U.S. Application Data
(60) Provisional application No. 60/401,710, filed on Aug. 7, 2002.

(51) Int. Cl. G08B 1/00

(52) U.S. Cl. 340/531; 379/39; 348/152

(57) ABSTRACT

A security system is disclosed, which includes a transmitter for transmitting a data stream, and a camera module, coupled to the transmission means, for taking imagery of a location and converting the imagery to data for inclusion in the data stream. Apparatus, coupled to the transmission means and the camera module, is adapted to detect a security breach at the location, activate the camera module and activate the transmission means to transmit a data stream including the data from the camera module. The imagery taken by the camera module consists of at least one of audio/video imagery and video imagery.

### CROSS-REFERENCE TO RELATED APPLICATIONS

This application claims the benefit of Provisional Application Serial No. 60/401,710, filed Aug. 7, 2002.

### FIELD OF THE INVENTION

This invention relates to security systems and methods.

### BACKGROUND OF THE INVENTION

Security systems are becoming increasingly more important for protecting homes and businesses and for deterring illegal and unauthorized activities. In fact, home and office security systems are becoming commonplace in modern society. Some security systems are actually configured to provide warnings when an emergency situation, like a fire or an unauthorized or illegal entry, occurs in the premises. Still other security systems are configured to be monitored over existing telephone lines by a remotely located security company, in which when an alarm condition occurs at the premises, such as an unauthorized or illegal entry or a fire, the security system transmits a signal to the security company via the telephone line, notifying the security company of the alarm condition. The security company then contacts the homeowner by telephone to verify whether the alarm condition is genuine or a false alarm. If the security company does not verify that the alarm condition is a false alarm, then the police or fire department is notified and dispatched to the premises. Although the art is replete with a vast array of security systems, needed is yet another that is easy to install, robust, highly reliable, inexpensive, and that is capable of collecting and dispatching useful information relating to security breaches.

### SUMMARY OF THE INVENTION

The above problems and others are at least partially solved and the above purposes and others realized in a security system embodying the principles of the invention in a preferred embodiment, in which the security system includes a transmitter for transmitting a data stream, and an audio/video camera module, coupled to the transmitter, for taking audio/video imagery of a location and converting the audio/video imagery to audio/video data for inclusion in the data stream. The immediate embodiment further includes apparatus, coupled to the transmitter and the video camera module, adapted to detect a security breach at the location, activate the audio/video camera module and activate the transmitter to transmit a data stream including the audio/video data from the audio/video camera module. Memory is also provided for storing audio/visual data generated by the audio/visual camera module. In one embodiment, the transmitter is adapted to transmit a telephonic signal that carries that data stream. In another embodiment, the transmitter is adapted to transmit a radio signal that carries the data stream. In yet another embodiment, the transmitter is adapted to transmit a television signal that carries the data stream. The immediate embodiment can incorporate a network of camera modules, if desired, each located at either the same location for redundancy and high reliability or at different locations for providing security at a plurality of designated locations. Camera module can be adapted and arranged to take only video data, if desired.

Another security system embodiment consists of a transmitter for transmitting a data stream and placing a call to a monitoring facility, and an audio/video camera module, coupled to the transmitter, for taking audio/video imagery of a location and converting the audio/video imagery to audio/video imagery data for inclusion in the data stream. The immediate embodiment further includes apparatus, coupled to the transmitter and to the audio/video camera module, adapted to detect a security breach at the location, activate the audio/video camera module and activate the transmitter to place a call to a the monitoring facility and transmit a data stream including the audio/video data from the audio/video camera module. Memory is also provided for storing audio/visual data generated by the audio/visual camera module. In one embodiment, the transmitter is adapted to transmit a telephonic signal that carries that data stream. In another embodiment, the transmitter is adapted to transmit a radio signal that carries the data stream. In yet another embodiment, the transmitter is adapted to transmit a television signal that carries the data stream. The immediate embodiment can incorporate a network of camera modules, if desired, each located at either the same location for redundancy or at different locations for providing security at a plurality of designated locations. Camera module can be adapted and arranged to take only video data, if desired.

Yet another security system embodiment consists of a transmitter for transmitting a data stream, and an audio/video camera module, coupled to the transmitter, for taking audio/video imagery of a location and converting the audio/video imagery to audio/video imagery data for inclusion in the data stream. First apparatus, coupled to the audio/video camera module, is adapted to detect a security threat and activate the audio/video camera module. Second apparatus, coupled to the transmitter and the audio/video camera module, is adapted to detect a security breach at the location, activate the audio/video camera module and activate the transmitter to transmit a data stream including the audio/video data from the audio/video camera module. Memory is also provided for storing audio/visual data generated by the audio/visual camera module. In one embodiment, the transmitter is adapted to transmit a telephonic signal that carries that data stream. In another embodiment, the transmitter is adapted to transmit a radio signal that carries the data stream. In yet another embodiment, the transmitter is adapted to transmit a television signal that carries the data stream. The first apparatus is a motion detector. In another embodiment, the first apparatus is sound detector. The immediate embodiment can incorporate a network of camera modules, if desired, each located at either the same location for redundancy or at different locations for providing security at a plurality of designated locations. Camera module can be adapted and arranged to take only video data, if desired.

Still a further security system embodiment consists of a transmitter for transmitting a data stream and placing a call to a monitoring facility, and an audio/video camera module, coupled to the transmitter, for taking audio/video imagery of a location and converting the audio/video imagery to audio/video imagery data for inclusion in the data stream. First apparatus, coupled to the audio/video camera module, is adapted to detect a security threat and activate the audio/video camera module. Second apparatus, coupled to the transmitter and to the audio/video camera module, is adapted to detect a security breach at the location, activate the audio/video camera module and activate the transmitter to place a call to a the monitoring facility and transmit a data stream including the audio/video data from the audio/video camera module. Memory is also provided for storing audio/visual data generated by the audio/visual camera module. In one embodiment, the transmitter is adapted to transmit a telephonic signal that carries that data stream. In another embodiment, the transmitter is adapted to transmit a radio signal that carries the data stream. In yet another embodiment, the transmitter is adapted to transmit a television signal that carries the data stream. The first apparatus is a motion detector. In another embodiment, the first apparatus is sound detector. The immediate embodiment can incorporate a network of camera modules, if desired, each located at either the same location for redundancy or at different locations for providing security at a plurality of designated locations. Camera module can be adapted and arranged to take only video data, if desired.

### BRIEF DESCRIPTION OF THE DRAWINGS

Referring to the drawing:

FIG. 1 is a diagramatic representation of a security system embodying the principles of the invention in a preferred embodiment; and

FIG. 2 is a schematic representation of the security system of FIG. 1 illustrating further details thereof.

### DETAILED DESCRIPTION OF PREFERRED EMBODIMENTS

A security system, constructed and arranged in accordance with the principle of the invention, includes a transmitter for transmitting a data stream, and an audio/video camera module, coupled to the transmitter, for taking audio/video imagery of a location and converting the audio/video imagery to audio/video data for inclusion in the data stream. A security breach detection apparatus, coupled to the transmitter and the video camera module, is adapted to detect a security breach at the location, activate the audio/video camera module and activate the transmitter to transmit a data stream including the audio/video data from the audio/video camera module. In response detecting a security breach, detection apparatus can be configured to also place a call to the monitoring facility for providing verbal communication ability between a person at the security system and personnel at the monitoring facility or with a person or people at a different location. Memory is also provided for storing audio/visual data generated by the audio/visual camera module. In one embodiment, the transmitter is adapted to transmit a telephonic signal that carries that data stream. In another embodiment, the transmitter is adapted to transmit a radio signal that carries the data stream. In yet another embodiment, the transmitter is adapted to transmit a television signal that carries the data stream. The security system can also incorporate a security threat detection apparatus, coupled to the audio/video camera module, adapted to detect a security threat, such as motion or sound, and activate the audio/video camera module. The security threat detection apparatus can, if desired, also be configured to activate the transmitter in the manner like that of the security breach detection apparatus.

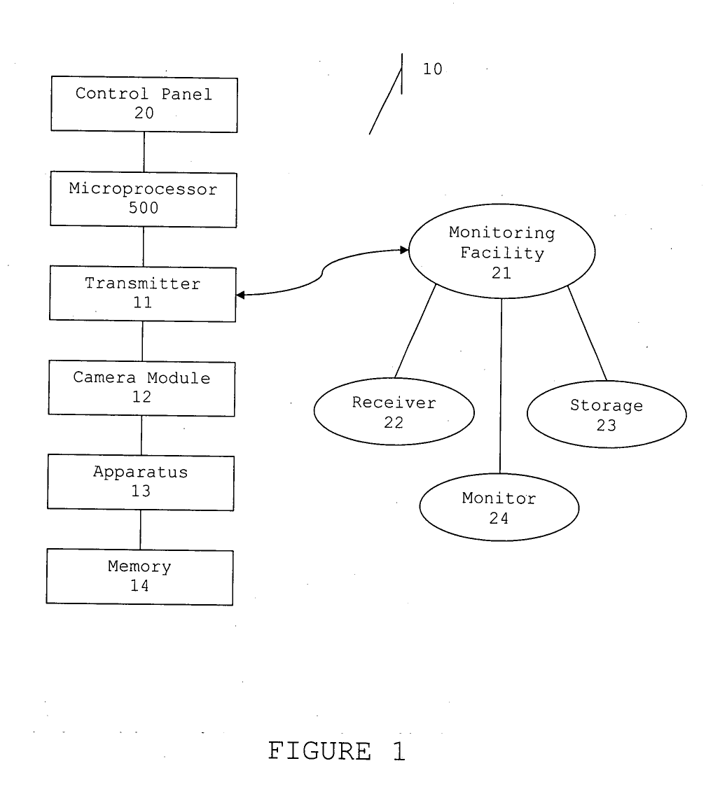

Turning now to the drawings, in which like reference characters indicate corresponding elements throughout the several views, attention is first directed to FIG. 1 in which there is seen a security system 10 including a series of electronically interconnected elements, namely, a transmitter 11, a camera module 12, apparatus 13 adapted and arranged to detect a security breach, and memory 14, each of which is known per se as a separate unit. The electronic coupling between transmitter 11, camera module 12, apparatus 13 and memory 14 is preferably by way of conventional hard wiring, although conventional wireless interconnections can be used, whether between certain ones of the elements of security system 10 or all of the elements of security system 10. Transmitter 11 is adapted and arranged to transmit a data stream, and camera module 12 is adapted and arranged to take audio/video imagery of a location and converting the audio/video imagery to audio/video data for inclusion in the data stream. Apparatus 13 is adapted and arranged to detect a security breach (i.e., the breaking of a window; an opening of a window; an opening of a door; a sound of a predetermined decibel level; a scream; a gunshot, etc.) at a selected location, and, in response to detecting a security breach, activate camera module 12, and activate transmitter 11 to transmit a data stream including the audio/video data from camera module 12. Preferably, the audio/video data generated by camera module 12 is stored into memory 14 for later use and, if desired, prior to its introduction into the data stream. In one embodiment, transmitter 11 is adapted to transmit a telephonic signal, that carries the data stream, over a publicly switched telephone network (PSTN). In another embodiment, transmitter 11 is adapted to transmit a radio signal, that carries the data stream, in which the radio signal is preferably a cellular radio signal sent over an existing cellular phone infrastructure. Other forms of radio communication can be used, consistent with the teachings of the invention. In yet another embodiment, transmitter 11 is adapted to transmit a television signal, that carries the data stream, such as a closed circuit television signal.

Security system 10 is to be installed so as to provide security at a fixed location where security is desired, such as at a home, a business, a vehicle (whether a car, a recreational vehicle, a boat) and, more particularly, at a point of entry to a home or a business or a vehicle, such as a door, a window, or at any location at which security is desired. In a preferred embodiment, camera module 12 is affixed at a location so that when activated takes audio/video imagery of a desired location, such as within a room, within a vehicle, at point of entry such as at a window, at a door, etc. Transmitter 11, apparatus 13, and memory 14, can be mounted proximate camera module 12, or elsewhere, such as at a concealed or secret location. Security system 10 can be powered from a dedicated power source such as by hard wiring, or a discrete power source, such as one or more lithium-cadmium batteries or any other battery form. In preferred embodiment, security system 10 is powered from a dedicated power source and incorporates a discrete power source, as explained, for providing security system 10 with backup power in the event that the dedicated power source is disabled. Preferably, security system 10 incorporates a control panel 20, which enables a user to “ARM” or activate security system 10 and “DISARM” or deactivate security system during periods of nonuse, and, for instance, define the operating parameters of security system 10 as may be provided by software instructions housed in memory, such as memory 14 or other memory. The provision of control panels, such as control panel 20, for use in operating, and controlling the operation of, security systems is well known. Control panel 20 can be mounted at any selected location, as may be desired.

Activation of security system 10 occurs when apparatus 13 detects a security breach. In response to apparatus 13 detecting a security breach, security system 10 is responsive and activates camera module 12 and transmitter 11 to transmit a data stream including the audio/video data from camera module 12, and stores the audio/video data from camera module 12 in memory 14. The audio/video data is intended to capture the security breach as it is taking place, providing audio and visual information as to the perpetrator(s) of the security breach, the nature of the security breach, etc.

When activated, transmitter 11 establishes a communication link with a remote monitoring facility 21, in accordance with the principle of the invention. As previously mentioned, transmitter 11 is adapted to transmit a telephonic signal, that carries the data stream, whether by way of a PSTN or by way of a wireless telephonic connection, namely, a cellular radio telephonic connection. In this regard, transmitter 11 is preferably configured to dial a predetermined phone number, or phone numbers, to establish a telephonic communication link with monitoring facility 21 over which the audio/visual data provided by camera module 12 is sent. Preferably, monitoring facility 21 has a receiver 22, associated with storage 23, which takes the phone call from transmitter 11 and receives and stores the audio/visual data from camera module 12 in storage 23, which can be accessed by monitoring facility 21 and displayed on a monitor 24 or other display device. Security system 10 is furnished with an identification code or number or signature or other designation, which is sent to receiver 22 over the communication link between transmitter 11 and receiver 22, which identifies security system 10 and its location.

In the embodiment in which transmitter 11 is adapted to transmit a television signal, that carries the data stream, such as a closed circuit television signal, it is to be understood that receiver 22 is adapted and arranged to receive and accept the television signal from transmitter 11 and store the audio/visual data from camera module 12 in storage 23, which can be accessed by monitoring facility 21 and displayed on a monitor 24 or other display device. The identification code or number or signature other designation of security system 10 is also sent to receiver 23 over the television signal in this embodiment.

Security system 10 is useful in that it functions to notify monitoring facility 21 of a security breach at a location specified by the identification assigned to security system 10 and send monitoring facility audio/video imagery of the security breach taking place, which is highly desirable because it not only can inform the monitoring facility of the nature of the security breach but also any perpetrator(s) carrying out the security breach. After the monitoring facility 21 determines the nature of the security breach with the aid of the audio/video data, monitoring facility 21 can then take the necessary action to render aid, such as notifying and dispatching, fire, police, medical, ambulatory aid, etc.

In accordance with the invention, security system 10 can also be furnished with apparatus 30 for detecting a security threat, such as a motion detector adapted and arranged to detect motion at a desired location. In this permutation of the invention, apparatus 30 is installed at a selected location at which motion is desired to be monitored and detected, such as at a point of entry or at some other selected location, which is intended to be the same location at which camera module 12 is mounted. However, apparatus 30 can be disposed at a location that is different from the location at which camera module 12 is located, such as at an exterior gate, entryway, driveway access, etc. Apparatus 30 is coupled to transmitter 11, and when activated is operative for detecting motion. In response to apparatus 30 detecting motion, security system 10 is responsive and activates camera module 12, which takes audio/video imagery of the location for the purpose of capturing audio/visual imagery of whatever caused the motion which was detected by apparatus 30. Camera module 12 is adapted and arranged to convert the audio/video imagery into audio/video data capable of being transmitted over a data stream and also stores the audio/video data in memory 14. The motion detected by apparatus 30 could possibly be one or more perpetrators approaching the location for the purpose of engaging in a security breach, such as unauthorized or illegal entry, etc. Apparatus 30 can, if desired, be configured not only to activate camera module 12 in response to detecting motion, but also transmitter 11 in the manner previously described for sending audio/video data collected by camera module 12 to monitoring facility 21. Although apparatus 30 is preferably a motion sensor, it can be a sensor for detecting sound or particular types of sound or levels of sound, a heat sensor, etc., or other device adapted and arranged to detect one or more particular kinds of stimuli that is indicative not of a security breach but of a security threat.

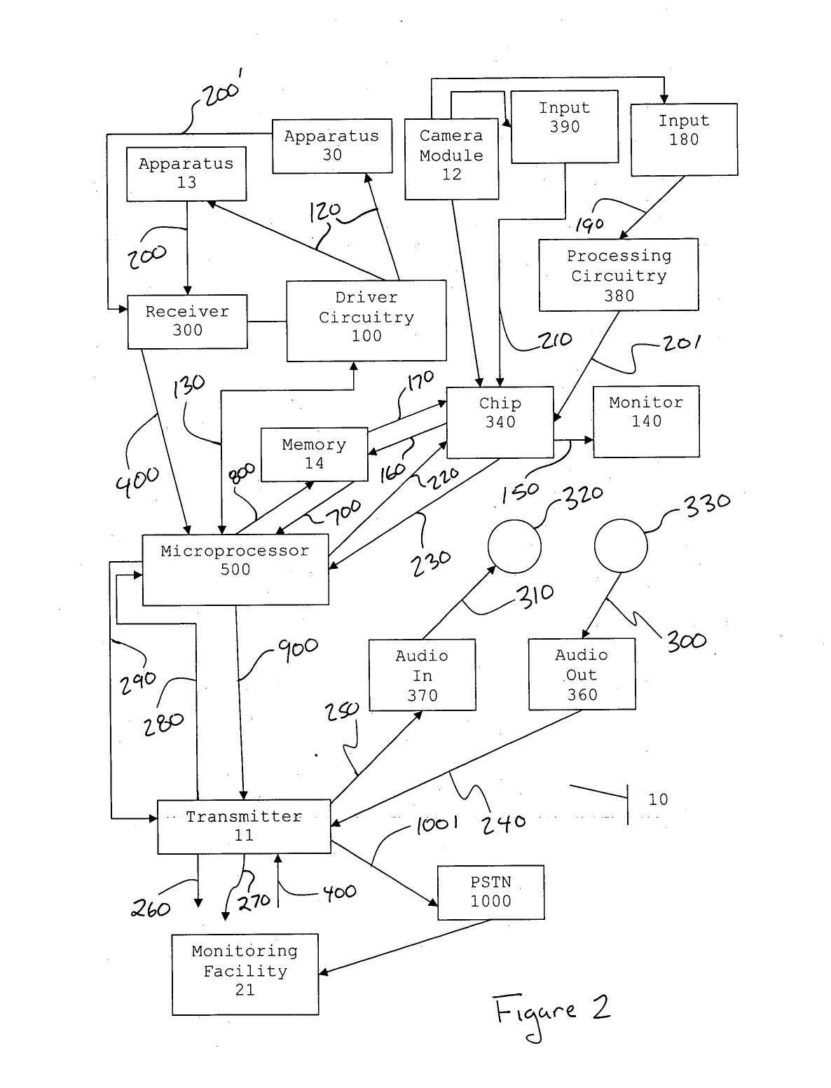

Turning to FIG. 2, a schematic representation of security system 10 is depicted and further details will now be discussed including preferred teachings concerning connections and the orientation of various interconnected components and associated operation. A microprocessor 500, which is part of security system 10 and incorporated, for instance, with transmitter 11 or perhaps with control panel 20, controls the operation of security system 10 in accordance with preprogrammed software instructions, and the execution and data flow of security system 10, and the operation of security system 10 in response to apparatus 13 detecting a security breach and apparatus 30 detecting a security threat. The first time power is applied to security system 10, microprocessor 500, using electrical connection 700, accesses and initializes/reads instructions from a software program stored in memory 14. The software instructions are executed by microprocessor 500, and direct the actions and operation of microprocessor 500. When microprocessor 500 stores status information or other data into memory 14, microprocessor 500 sends a memory storage address and the data to be stored across electrical connection 800 to memory 14 for storage.

Apparatus 13 is adapted to periodically or continuously send status information to transmitter receiver 300 across connection 200. This status information is then transferred from receiver 300 across connection 200. This status information is then transferred from receiver 300 across connection 400 to microprocessor 500. The software program executed by microprocessor 500 uses this information to determine what action(s) to take. A triggering of apparatus 13, caused by one or more events, causes microprocessor 500 to perform actions, such as communicate with control panel 20, command an alarm to sound if there is one provided, or start a timer within microprocessor 500, in which after a predetermined period of time microprocessor 500 initializes or otherwise activates camera module 12 and/or transmitter 11, and this is also the case with a triggering of apparatus 30, which sends information to receiver 300 via connection 200′. Microprocessor 500 uses connection 130 to command driver circuitry 100 to communicate with apparatus 13 across connection 120, in addition to control panel 20 and any alarm device. When microprocessor 500 determines that due to an event triggered by apparatus 13 it is necessary to communicate with monitoring facility 21, microprocessor 500 sends messages, such as dialing data, location information, and specific status, across connection 900 to transmitter 11, which, for instance, is responsive and places a telephone call to monitoring facility 21 across connection 270. Microprocessor 500 can be considered part of apparatus 13, if desired, and also apparatus 30.

Camera module 12 incorporates compression chip 340, which receives command and control information from microprocessor 500 across connection 220 for acquisition of audio/video imagery and data and the positioning of camera module 12. Connection 230 is the path used by compression chip 340 to send status information and other data to microprocessor 500. It is to be understood that compression chip 340 is considered part of camera module 12, whether it is actually physically incorporated with or at camera module 12 or at a different location, such as at control panel 20, transmitter 11, etc. Also, although one compression chip is disclosed, the invention may incorporate a plurality of compression chips, including, for instance, one or more video compression chips and one or more audio/video compression chips.

Audio/video signals are received by compression chip 340 from camera module 12 across connection 210. This data is manipulated within compression chip 340 using well known audio/video compression techniques. This compressed audio/video data is stored in memory 14 using connection 160. Compression chip 340 thus takes audio/visual imagery taken by camera module 12 and converts it into audio/visual data capable of being transmitted in a data stream as discussed supra. Compression chip 340 can be considered part of camera module 12, if desired.

Although audio/visual imagery taken by camera module 12 is stored in memory 14, it can be maintained by other memory or storage. When initiated by microprocessor 500 using, for instance, connection 800, microprocessor 500, in a particular embodiment, accesses memory 14 and sends stored audio/video imagery to compression chip 340 across connection 170 for conversion into audio/visual data capable of being transmitted into a data stream. If desired, this audio/video data may be sent across connection 150 to a monitor 140 of security system 10. Compression chip 340 can receive audio/visual imagery directly from camera module 12 if desired, in which after conversion the audio/video data capable of being transmitted in a data stream is sent to memory 14 for storage.

A wireless video camera input 180 can be used with security system 10 so as to establish a wireless connection to camera module 12. In this aspect of the invention, wireless audio/video information is sent to wireless video processing circuitry 380 via connection 190 where, for instance, it is transformed into digital data for use by the video data compression chip 340. The data is sent to compression chip 340 from wireless video processing circuitry 380 across, for instance, connection 201. If microprocessor 500 determines a security breach as provided by impulses provided by apparatus' 13, it commands compression chip 340, using connection 220, to begin capture of audio/video data at the locale of the breach. This data is then transferred to memory 14 by way of connection 160. When a frame of data has been sent to memory 14, compression chip 340 notifies microprocessor 500 that a frame is complete across connection 230. Microprocessor 500 is responsive and sends a command across connection 800 to memory 14 that directs memory 14 to retrieve this frame of data and send it across connection 700 to microprocessor 500. Microprocessor 500 formats this frame of data for transmission across connection 290 to transmitter 11, which sends this data to monitoring facility 21 across, for instance, the airwave (e.g., wireless) indicated by connection 270. Multiple audio/video input devices 390 and/or 180 may be incorporated into security system 10 using the same methodology. As previously intimated, it is to be understood that communication between transmitter 11 and monitoring facility 21 (depicted only in FIG. 1) can be made over PSTN 1000 via connection 1001.

And so the invention provides systems and methods for sending compressed audio/video data over existing telephonic infrastructures, using ground telephonic communication pathways and/or wireless telephonic communication pathways, to an external monitoring facility, such as monitoring facility 21. Given that the invention exploits telephonic pathways for use in transmitting a data stream, the invention also includes the provision of establishing a two-way telephonic communication link between security system 10, namely, transmitter 11, and monitoring facility 21. Also, with the ability to send audio and audio/video data to an external monitoring facility center, the audio and audio/video can be associated with each other.

As a matter of example, when microprocessor 500 determines that it is necessary to communicate with monitoring facility 21, a command set is sent across, for instance, connection 290 to transmitter 11, which sends radio signals containing the protocol appropriate for its type to monitoring facility 21 using wireless connection 260. Monitoring facility 21 may return data commands or audio voice information to transmitter 11 using, for instance, wireless connection 400.

When audio data from monitoring facility 21 enters security system 10 via transmitter 11, in a particular embodiment it is transferred across connection 250 to an audio input circuit 370 where the information is prepared to be sent to, for instance, an audio speaker 320 of security system 10. The audio signals are sent from the audio input circuit 370 across connection 310 audio speaker 320. When it is necessary to provide audio from the security system 10 to monitoring facility 11, or other designation, an audio microphone 330 of security system 10 is used to send audio signals across connection 300 to audio output circuitry 360. Audio signals are prepared for transmission by transmitter 11 and are sent, for instance, over connection 240. Transmitter 11 then sends the radio frequency audio signals to monitoring facility 21, or other designation, over connection 260.

The invention has been described above with reference to a preferred embodiment. However, those skilled in the art will recognize that changes and modifications may be made to embodiment without departing from the nature and scope of the invention. For instance, although camera module 12 is adapted and arranged to collect audio/video imagery, it can be configured to collect only video imagery, if desired, in which compression chip 340 would be adapted and arranged to receive video imagery from camera module 12 and convert/compress the video imagery into video data capable of being transmitted in a data stream.

Rather than just one camera module 12, security system 10 can incorporate a network of camera modules, if desired, each positioned at either the same location for redundancy or for providing different imagery perspectives or at different locations for providing security at a plurality of designated locations. Consistent with this, the invention can also incorporate a plurality of apparatus 13 (the security breach detection apparatus) for providing the ability to detect security breaches at a plurality of different locations, and a plurality of apparatus 30 (the security threat detection apparatus) for providing the ability to detect security threats at a plurality of locations. Having a plurality of camera modules, security breach detection apparatus (e.g., apparatus 13), and security threat detection apparatus (e.g., apparatus 30) in a security system constructed and arranged in accordance with the principle of the invention, provides a wide range of security coverage, and/or redundancy for fail-safe and/or highly reliable operation. It is to be understood, that apparatus 13 and apparatus 30 can, if desired, be the same apparatus, and that a plurality of such apparatus can be used in a security system constructed and arranged in accordance with the invention. Also, memory 14 can maintain map data of the location at which security system 10 is maintained, that can be sent in the data stream to monitoring facility 21 identifying by way of a map the identification of the location of the house, business, vehicle, boat, plane, etc., at which the security breach or threat is taking place. As a matter of example, the map can include a floor plan of the house or business at which the security system is located, and a designation of the location at which the security breach took place, such as at a particular door, a particular window, etc. This aspect is particularly advantageous when security system 10 is configured with a plurality of camera modules each located at a different location, in which a security breach at each location can be designated by way of a specified map adapted to be transmitted in the data stream facilitated by security system 10. The map can be stored at a monitoring facility, if desired, and the security system can send identifying information for display on the map.

Various further changes and modifications to the embodiment herein chosen for purposes of illustration will readily occur to those skilled in the art. To the extent that such modifications and variations do not depart from the spirit of the invention, they are intended to be included within the scope thereof.

Having fully described the invention in such clear and concise terms as to enable those skilled in the art to understand and practice the same, the invention claimed is:

1. A security system comprising:
a transmitter for transmitting a data stream;
a camera module, coupled to the transmitter, for taking imagery of a location and converting the imagery to data for inclusion in the data stream; and
apparatus, coupled to the transmitter and the video camera module, adapted to detect a security breach at the location, activate the camera module and activate the transmitter to transmit a data stream including the data from the camera module;
wherein the imagery comprises at least one of audio/video imagery and audio imagery.

2. The security system of claim 1, further comprising memory for storing data generated by the camera module.

3. The security system of claim 1, wherein the transmitter is adapted to transmit a telephonic signal that carries that data stream.

4. The security system of claim 1, wherein the transmitter is adapted to transmit a radio signal that carries the data stream.

5. The security system of claim 1, wherein the transmitter is adapted to transmit a television signal that carries the data stream.

6. A security system comprising:
a transmitter for transmitting a data stream and placing a call to a monitoring facility;
a camera module, coupled to the transmitter, for taking imagery of a location and converting the imagery to data for inclusion in the data stream; and
apparatus, coupled to the transmitter and to the camera module, adapted to detect a security breach at the location, activate the camera module and activate the transmitter to place a call to a the monitoring facility and transmit a data stream including the data from the camera module;
wherein the imagery comprises at least one of audio/video imagery and audio imagery.

7. The security system of claim 6, further comprising memory for storing data generated by the camera module.

8. The security system of claim 6, wherein the transmitter is adapted to transmit a telephonic signal that carries that data stream.

9. The security system of claim 6, wherein the transmitter is adapted to transmit a radio signal that carries the data stream.

10. The security system of claim 6, wherein the transmitter is adapted to transmit a television signal that carries the data stream.

11. A security system comprising:
a transmitter for transmitting a data stream;
a camera module, coupled to the transmitter, for taking imagery of a location and converting the imagery to data for inclusion in the data stream;
first apparatus, coupled to the camera module, adapted to detect a security threat and activate the camera module; and
second apparatus, coupled to the transmitter and the camera module, adapted to detect a security breach at the location, activate the camera module and activate the transmitter to transmit a data stream including the data from the camera module;
wherein the imagery comprises at least one of audio/video imagery and audio imagery.

12. The security system of claim 11, further comprising memory for storing data generated by the camera module.

13. The security system of claim 11, wherein the transmitter is adapted to transmit a telephonic signal that carries that data stream.

14. The security system of claim 11, wherein the transmitter is adapted to transmit a radio signal that carries the data stream.

15. The security system of claim 11, wherein the transmitter is adapted to transmit a television signal that carries the data stream.

16. The security system of claim 11, wherein the first apparatus comprises a motion detector.

17. The security system of claim 11, wherein the first apparatus comprises sound detector.

18. A security system comprising:
a transmitter for transmitting a data stream and placing a call to a monitoring facility;
a camera module, coupled to the transmitter, for taking imagery of a location and converting the imagery to imagery data for inclusion in the data stream;
first apparatus, coupled to the camera module, adapted to detect a security threat and activate the camera module; and
second apparatus, coupled to the transmitter and to the camera module, adapted to detect a security breach at the location, activate the camera module and activate the transmitter to place a call to a the monitoring facility and transmit a data stream including the data from the camera module;
wherein the imagery comprises at least one of audio/video imagery and audio imagery.

19. The security system of claim 18, further comprising memory for storing data generated by the camera module.

20. The security system of claim 18, wherein the transmitter is adapted to transmit a telephonic signal that carries that data stream.

21. The security system of claim 18, wherein the transmitter is adapted to transmit a radio signal that carries the data stream.

22. The security system of claim 18, wherein the transmitter is adapted to transmit a television signal that carries the data stream.

23. The security system of claim 18, wherein the first apparatus comprises a motion detector.

24. The security system of claim 18, wherein the first apparatus comprises sound detector.
